(19) United States
(12) Patent Application Publication
(10) Pub. No.: US 2009/0259484 A1
(43) Pub. Date: Oct. 15, 2009

(54) SYSTEMS AND METHODS FOR EMPLOYEE COMPENSATION PLANNING

(76) Inventor: Terrance L. Lillie, Emerald Hills, CA (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(21) Appl. No.: 12/417,579

(22) Filed: Apr. 2, 2009

Related U.S. Application Data
(60) Provisional application No. 61/042,223, filed on Apr. 3, 2008.

(51) Int. Cl. G06Q 10/00; G06F 17/30

(52) U.S. Cl. 705/1; 707/104.1; 707/E17.044

(57) ABSTRACT

Systems and methods for generating a compensation plan for an enterprise include core invariant modules and a plurality of dynamic modules. Enterprise-specific data is manipulated according to a set of enterprise-specific and enterprise-agnostic rules for compensation planning to calculate elements of the compensation plan, and those elements are presented for user review and modification according to view templates. As modifications are made to previously calculated elements of the compensation plan, the plan is recomputed and the effect of the modifications presented.

### RELATED APPLICATION

This application is a Non-Provisional of, incorporates by reference in its entirety, and hereby claims the priority benefit of U.S. Provisional Patent Application No. 61/042,223, entitled “Systems and Methods for Employee Compensation Planning”, filed 3 Apr. 2008 by the present inventor and assigned to the assignee of the present invention.

### FIELD OF THE INVENTION

The present invention relates to platforms configured to facilitate total compensation package planning for workforces that may be made up of large numbers of geographically dispersed employees.

### BACKGROUND

Although there are several existing solutions that are marketed under the guise of compensation planning software or systems, these solutions tend to be very expensive to implement and difficult to configure and maintain. This is perhaps not surprising, inasmuch as compensation planning for a global workforce is a complex problem. The variety and dynamic character of government-mandated and company-imposed rules for employee compensation virtually necessitate complex solutions.

Given the complex nature of the problem, to date most compensation planning providers have developed applications that are specifically configured to the needs of their clients. Such solutions tend to offer limited functionality and, when needs vary from client to client, or when they change from year to year or by geographic region, the clients must return to the providers for software reprogramming, application updates and reconfigurations. This process is both time consuming and expensive.

In general then, this “hard-wired” approach to compensation planning systems is inherently self-limiting because the business either imposes severe restrictions on the client base or the many implementations approach simply will not scale efficiently for the developer. Consequently, what is needed are improved systems and methods for compensation planning.

### SUMMARY OF THE INVENTION

In one embodiment of the present invention, a configurable system for generating a compensation plan for an enterprise is provided. The system includes an invariant core with a core business logic and presentation module, a core database module, and a computation engine module. Also included are a plurality of dynamic modules, for example, a data dictionary module, a computation rule module, an extensible database schema module, and a view template module. The dynamic modules are accessible to modules comprising the invariant core. Further, a database that stores data specific to the enterprise and readable by at least one of the modules comprising the invariant core and one or more of the dynamic modules is provided.

The core business logic and presentation module may be configured to manipulate data received from the database according to a rule set defining the compensation plan for the enterprise. Such a rule set may include enterprise-specific as well as enterprise-agnostic rules (for example, compensation rules defined by a government, a nation, a region, a locality, a custom, etc.). The core business logic and presentation module may also include presentation rules which define one or more view templates, which define how variables and other elements are presented to users of the system. The computation engine module may be configured to compute such variables for a compensation plan according to editable compensation rules defined through mathematical expressions stored in the data dictionary module.

Further embodiments of the invention provide for generating a compensation plan for an enterprise, by receiving enterprise-specific data from a database; modifying the enterprise-specific data according to a schema to produce modified data compatible with other data in the compensation plan; listing the modified data and information about the enterprise-specific data in a data dictionary; manipulating the modified data according to a rule set for compensation planning to produce manipulated data; calculating elements of the compensation plan, using the manipulated data, according to one or more computation rules described in the data dictionary; generating variables within the compensation plan for the enterprise based on the calculated elements; and presenting for user viewing the generated variables of the compensation plan.

The variables within the compensation plan may be generated at a server and presented via view templates displayed by a web browser at a client. The view templates may define planning pages which display portions the compensation plan. Via these planning pages, users may provide modifications to the compensation plan (or elements thereof) and the variables within the compensation plan will be automatically recomputed based on such modifications.

As indicated above, the rule set may include both enterprise-specific rules and enterprise-agnostic rules, for example one or more rules defined by a government or by industry best practices, for example. The rule set is editable and defines the compensation plan through mathematical expressions. Importantly, the rule set includes a description of an order in which compensation plan calculations must be performed. This way, data dependencies and other computational hierarchies are preserved.

These and other features and embodiments of the present invention are discussed further below.

### BRIEF DESCRIPTION OF THE DRAWINGS

The present invention is illustrated by way of example, and not limitation, in the figures of the accompanying drawings, in which:

FIG. 1A illustrates an example of a system for implementing a compensation planning software application, consistent with some embodiments of the present invention;

FIG. 1B illustrates an example of a software architecture for a compensation planning application configured in accordance with embodiments of the present invention;

FIGS. 2A-2C are examples of planning pages through which a manager or other individual responsible for planning compensation of others can view information relevant to that process, consistent with some embodiments of the present invention;

FIG. 3 illustrates an exemplary process for generating a compensation plan for an enterprise, consistent with some embodiments of the present invention;

FIG. 4 illustrates an exemplary process for generating a compensation plan for an enterprise, consistent with some embodiments of the present invention; and

FIG. 5 illustrates an example of a data entry template for a data dictionary editor consistent with embodiments of the present invention.

### DETAILED DESCRIPTION

Described herein are systems, computer readable media, and methods to facilitate total compensation package planning for workforces that may be made up of large numbers of geographically dispersed employees. In one embodiment, the present invention is instantiated as a configurable, computer-based application that supports variability in compensation planning rules and data representation without requiring that the application be reprogrammed. This flexibility permits users of the computer-based application to update or revise methodologies used for compensation planning (e.g., in response to company-based initiatives or government-mandated regulations for particular jurisdictions) as needed.

As will be apparent from the description below, various embodiments of the present invention may be implemented with the aid of computer-implemented processes or methods (a.k.a. programs or routines) that may be rendered in any computer language. As an example, certain modules that comprise one instantiation of the present invention may be written in a compiled language, such as Java™ or the like. Moreover, some portions of this detailed description that follow are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a programmed computer system, or similar electronic computing device, that manipulates and transforms data represented as physical (electronic) quantities within the computer system's registers and memories into other data similarly represented as physical quantities within the computer system memories or registers or other such information storage, transmission or display devices.

Where embodied as computer-readable instructions, the present application may be executed on or by a computer system. In such instances, the application may reside as a computer program stored in a computer readable storage medium, such as, but not limited to, any type of disk including floppy disks, optical disks, CD-ROMs, and magnetic-optical disks, read-only memories (ROMs), random access memories (RAMs), electrically programmable ROMs (EPROMs), electrically erasable programmable ROMs (EEPROMs), flash memories, magnetic or optical cards, or any type of media suitable for storing electronic instructions. The algorithms and processes presented herein are not inherently related to any particular computer or other apparatus.

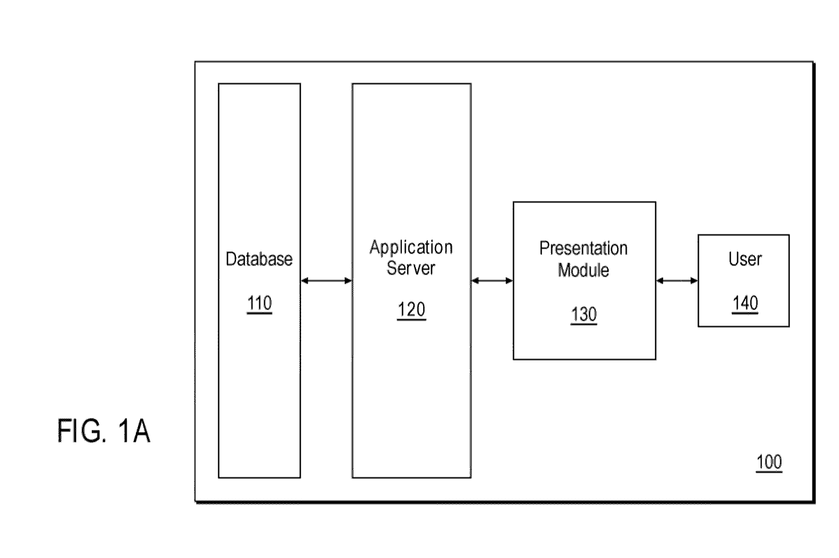

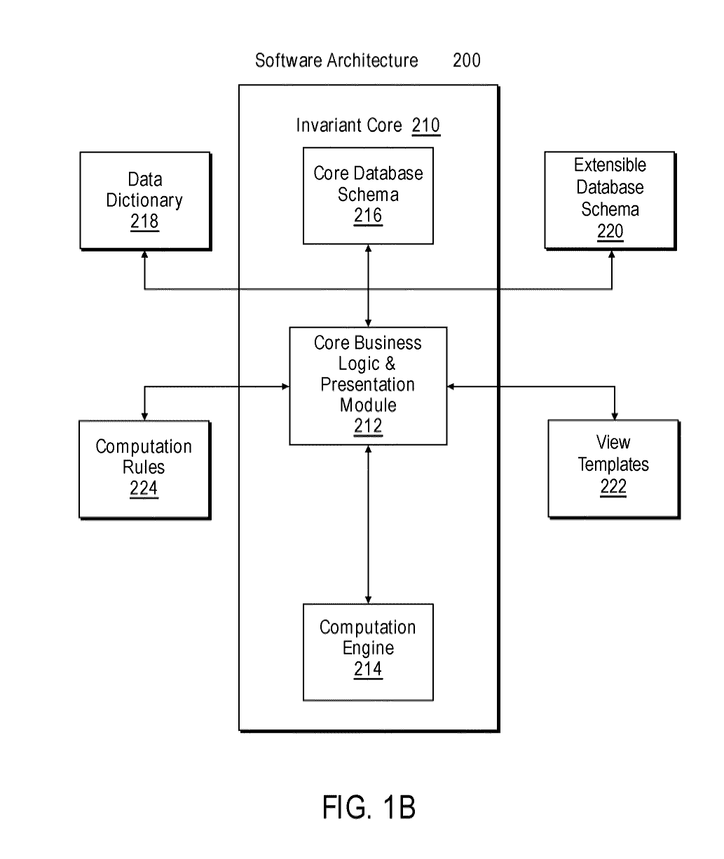

FIG. 1A illustrates an example of a system 100 for implementing a compensation planning software application. System 100 may include a database 110, an application server 120, a presentation module 130, and a user 140. Database 110 may include actual data (e.g., employee names, compensation data, etc.) for an enterprise and may be maintained by, for example, the enterprise or another entity at the direction of the enterprise. Database 110 may be resident on, for example, server 120 or an external memory device, such as a disk drive. Server 120 may be any software application server, such as IBM's™ WebSphere Application Server™ (WAS), Red Hat's JBoss™ application server, etc. and presentation module 110 may be, for example, a computer system configured with a web browser such as Microsoft's™ Internet Explorer™. User 140 may be any user of system 100, such as an executive, manager, and/or employee of an enterprise.

FIG. 1B illustrates an example of a software architecture 200 for an application configured in accordance with an embodiment of the present invention. Application 200 may be installed on server 120 and accessible to user 140 via presentation module 130. As shown, a modularized approach is used so that the overall application is made up of certain modules comprising an invariant core 210 of the application, and other dynamic modules which are highly customizable. The modules that make up the invariant core of the application may include a core business logic and presentation module 212, a computation engine module 214 and/or a core database schema module 216. The dynamic modules of this architecture may include a data dictionary module 218 (which may be memory resident when the application is executing on a computer system such as server 120), an extensible database schema module 220, a view templates module 222, and a computation rule module 224. This modularized approach to software implementations of the present compensation planning system allows for a wide variety of user-specific implementations without the need to reprogram vast libraries of, for example, business rules, presentation formats, and other elements thereof. Not shown in this illustration is a database, such as database 110, that stores the actual data (e.g., employee names, compensation data, etc.) for an enterprise, but those of ordinary skill in the art will appreciate that such a database exists and is made accessible to the application during run time.

In some implementations, the dynamic ones of the different software modules are represented in text-based, extensible markup language (XML) form. In such instances, unique implementations of the software application can then be created by editing a set of XML templates that define, for example:

a. user-specific data elements;

b. application calculations (e.g., validation rules);

c. compensation plan descriptions; and/or

c. user-facing data representations (i.e., view templates).

These XML templates may be configured through an administrative user interface that abstracts the complexity of the configuration details from the user. This allows for a high level of configurability with respect to the rules and data representations governing a particular enterprise's compensation planning process without introducing significant complexities to the actual programming task.

As shown in the illustration, at the heart of the software architecture lies the core business logic and presentation module 212. This module is responsible for manipulating the user data according to a defined rule set for compensation planning. While some of these rules (e.g., those which are applicable to any, or virtually any, enterprise) may be specified as part of the application's invariant core (which encompasses application logic that is common to all instantiations of the application, i.e., those portions of the application which are enterprise agnostic, and/or provides functionality common to all such instantiations and that is used as a basis for performing customizations, e.g., a compensation engine), many such rules will be enterprise-specific and so can be specified as part of the computation rule module 224. That is, the core business logic module 212 may be configured to draw upon enterprise-specified rules described in the computation rules module 224 in order to produce results that comply with that enterprise's policies for compensating its employees. Further, customary, local, regional, national and/or other governmental rules pertaining to a compensation package of an employee of an enterprise can be specified as part of either the extensible compensation rule module 224 or data dictionary 218 and, hence, can be customized for an enterprise's needs.

The core business logic and presentation module 212 may include presentation rules applicable to or desirable for any (or virtually any) enterprise. These presentation rules may define how data is formatted and/or presented to users for use in the compensation planning process. The presentation rules may make use of detailed view templates to prepare a planning page to be displayed to a user.

The view template module is configured to process the view templates to facilitate formatting and display of data defined by the data dictionary module. For example, the view template module may read the view templates, retrieve associated data described by the data dictionary module and produces display objects for the presentation module.

View templates may be specified by a configurable view template module 222. Such view templates may be organized by business unit, country, page identifier, porlet identifier, view identifier or other criteria. Default view templates may be made available in the event a specific view that does not match any of these criteria is required. In some embodiments, this scheme is extensible so that if there is a need for different views for job families, e.g., executive managers versus salaried employee managers that need can be accommodated. Templates that are differentiated by any indicator field in the demographic input file (usually generated by the end user's enterprise resource planning system) can be created.

The core business logic and presentation module 212 may make use of computation engine module 214 to perform calculations specified by computation rules for compensation planning. As indicated above, the actual compensation rules may be stored in the data dictionary 218. By specifying the computation rules separate from the computation engine itself, the present system allows for a high degree of customization on a per-user (i.e., per-enterprise) basis.

The compensation rules may be derived from national, regional or local statutory or other governmental requirements, as well as other sources (for example, recognized “best practices” within a given industry may be expressed as compensation rules within the present compensation planning system). As such, the rules are subject to and can be changed over time (for example, as statutory schemes are revised or amended, as an enterprise adopts new policies or procedures, or as industry best practices evolve to accommodate new circumstances or business organizations). The rules may be expressed as equations (to be evaluated by the computation engine) and stored in the data dictionary, for example as strings that define a series of arithmetic and/or conditional operations. Such strings may be stored within appropriate fields of tables that comprise the data structure of the data dictionary.

The computation engine module 214 may include algorithms to compute various results, as directed by the various computation rules. During a planning cycle, as a user makes modifications to some variables, the computation engine module 214 may automatically make modifications to other variables affected by the user inputs and those changes may be reflected via one or more views provided by presentation module 130. Generally, such computations are run against data stored in the database 110 and the data dictionary 218 is used to assign variable names to each field and to identify a location in the database where the corresponding data element can be found.

Of course, the core business logic and presentation module 212 generally operates on user-supplied data that arrives at the module in an expected format. The rules defining that format are specified in the core database schema 216 and/or the extensible database schema 220. More specifically, these schemas collectively define the various tables which store the user data, fields in each of these tables, and relationships between those fields and tables. User data may be stored in and/or retrieved from a database, such as database 110.

In some instances, data dictionary 218 may be an XML file that contains mappings between variable names, database fields and calculation equations. However, defining the data dictionary in such a fashion tends to be somewhat unwieldy. Accordingly, it may be preferable to instead construct the data dictionary using a data dictionary editor.

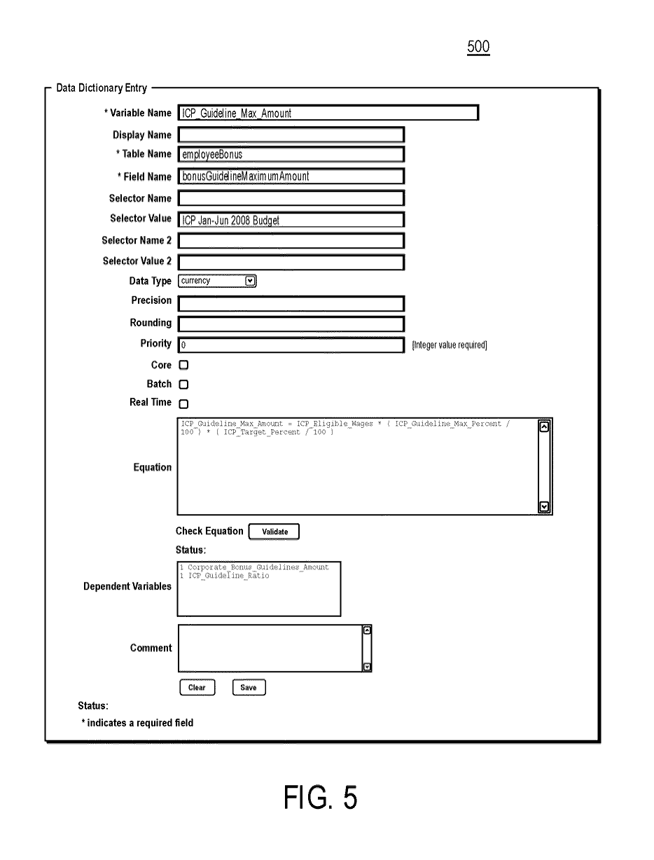

Referring now to FIG. 5, which illustrates an example of a data entry template 500 for a data dictionary editor consistent with embodiments of the present invention, the data dictionary is typically built prior to run time, e.g., at the start of a compensation planning cycle. This may be done by defining variables, tables, fields, and other data structure attributes. For example, as shown in the illustration, a number of data dictionary attributes, as well as the actual equations defining the compensation rules, can be entered through the data dictionary editor template and stored to the appropriate fields, etc. of the data dictionary. Thereafter, when the application is run, the data dictionary is loaded into memory and made accessible to the business logic and presentation module 212. Because the definitions maintained in data dictionary reside outside of the application's invariant core, it is possible to change data definitions and the mathematical interaction between data elements, which define the behavior of the application, without modifying the core elements or modules of the application. This makes the overall application highly flexible and adaptable for different enterprises.

A further important aspect of the present invention is a calculation index, that is, a table or other data structure defining an order in which computations are to be performed when computing affected variables for a compensation plan when a cross-calculation in initiated by any update (e.g., an update initiated by a user). This calculation index may be built as a companion to the data dictionary as new data dictionary variables and equations are entered. At run time, the calculation index is consulted by the computation engine, which invokes the referenced equations in the order described in the calculation index as updates are received.

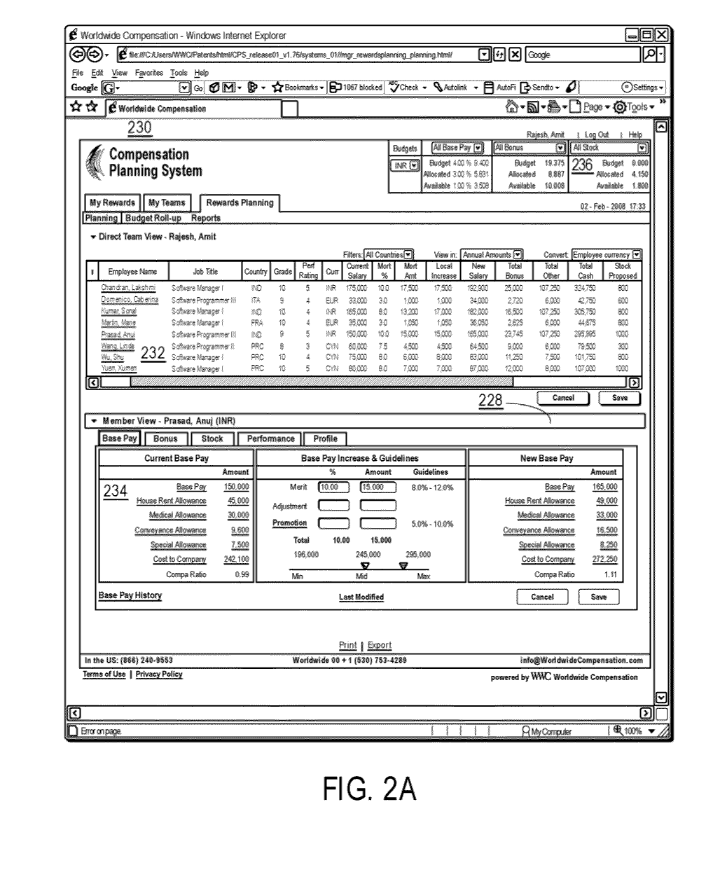

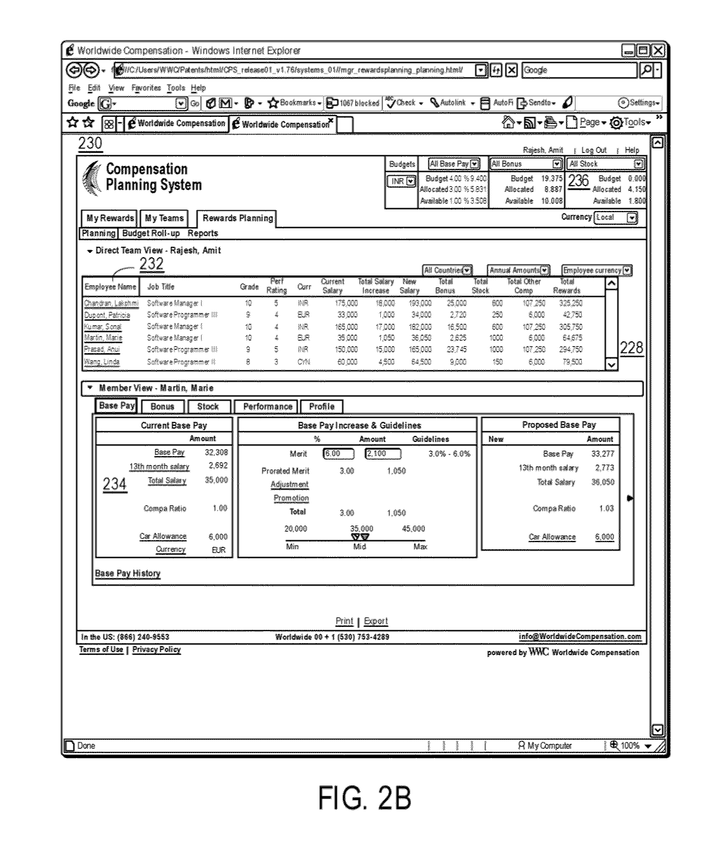

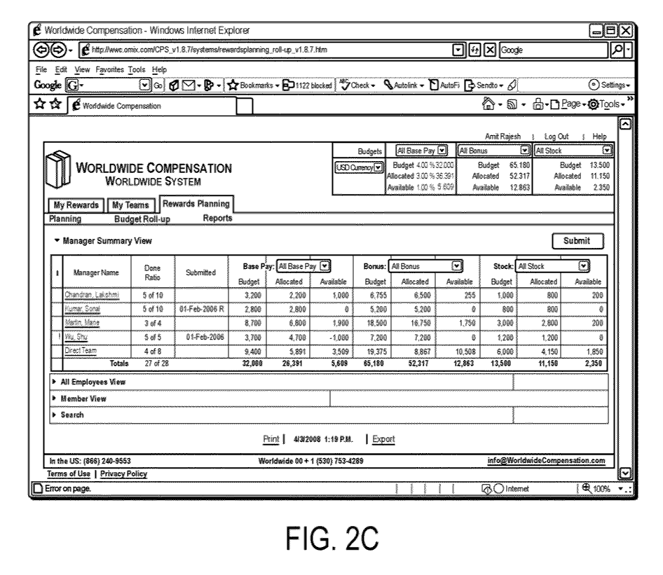

Having thus examined the overall architecture of a software application that provides compensation planning facilities in accordance with an embodiment of the invention, we now turn to various aspects of the application in greater detail. We begin with the view templates. These templates may be used to create a planning page, examples of which are shown in FIGS. 2A-C, and are the means by which users may interact with the rules and processes for determining compensation packages for employees within an enterprise and generate a compensation plan for the enterprise. The examples set forth in FIGS. 2A and 2B show a particular planning page 228 displayed within a browser window 230. Thus, it should be apparent that some instantiations of the present application may be run as server-hosted applications accessible through a conventional web browser, although this is not a requirement of the present invention. In other instances, dedicated client applications may be used to present the various views.

The view templates and planning pages allow the present compensation planning application to represent data in such a way that employee compensation information may be configured by business unit, geographic region, or both. Because different managers and others with responsibility for compensation planning within an organization may have need for different data representation requirements, the specification of the view templates is left to a configurable module that exists outside of the invariant core of the application. In one example, the view templates are instantiated as XML representations of client-facing dynamic hypertext markup language (HTML) components, such as datagrids and rollbars, which representations are used to build these elements dynamically at planning page generation time. The generation of a specific dynamic HTML component may then be structured by the view template conditioned to the underlying data described by the data dictionary.

The example shown in FIG. 2A is a planning page through which a manager or other individual responsible for planning compensation of others can view and/or enter information relevant to that process. The planning page may consist of several elements, such as datagrid 232, rollbar 234, and budget window 236. Datagrid 232 presents information about individual team members for which the manager or other user is responsible. This information will vary by enterprise, but may include elements such as employee name, job title, country of employment, grade level, performance rating, currency in which the individual is paid, current salary, presently scheduled compensation increases (e.g., broken down by merit component, bonus components, etc., in both total amounts and percentages over current compensation), and any non-cash compensation components (e.g., stock allocations, etc.). By presenting such a team-level view, the present system affords the manager the opportunity to study compensation planning at an overall workgroup (or other) level.

Of course, higher level managers or executives may obtain different views. For example, higher level managers may wish to review compensation details, for example, at the workgroup or company level, rather than at the individual employee level. Suitably programmed view templates can accommodate this need, as well as provide the ability to drill down to the employee-specific level (e.g., via hyperlinks to other views), if so desired. Likewise, lower level managers or others may need to review the compensation details at an even finer granularity than that presented in the example shown in FIG. 2A. For example, rather than viewing compensations details for an entire workgroup whose members are distributed across different geographic locations, some managers may need to review information for only those employees assigned to particular offices, etc., or even just a single employee. Suitably programmed view templates may be used to generate planning pages which may accommodate this need, as well as provide the ability to provide higher level views (e.g., at the workgroup or other levels as shown in FIG. 2C), if so desired.

Returning to FIG. 2A, details for an individual employee's compensation package (at a level appropriate for the subject manager's planning purposes) are presented in rollbar 34. In this example, the details for one of the employees identified in the team-level view are further set forth in the rollbar portion of the planning page. The rollbar view gives a very fine grained view of the components that go into the individual employee's compensation package and allow the reviewing manager to make adjustments to those elements of the compensation package as appropriate.

For example, the illustration shows that there are many components involved in computing the subject employee's base pay. Similar details can be provided for the employee's bonus package, stock package, other non-cash compensation and other compensation factors through an appropriate selection of a tab at the top of the rollbar view. Exemplary tabs may provide access to details concerning the employee's performance review and/or professional employment record or profile. Of course, the use of tabs is purely arbitrary and other visual indicators may be used in their place.

One item of interest is that the components of base pay (and other compensation package factors) that may be displayed within the rollbar 234, may be governed by the enterprise and country-specific rules for determining that employee's compensation. So, for example, for an employee based in India, in addition to base pay, factors such as a house rent allowance, a medical allowance, a conveyance allowance, and a special allowance all must be taken into consideration. Compare that with the example shown in FIG. 2B, which illustrates compensation factors for an employee based in France. Here, only base pay and a 13^{th} month allowance need to be accounted for. This ability to provide both enterprise- and governmental-specific compensation factors on a per-employee basis within the view templates and/or planning pages is made possible by the use of configurable compensation rules available in, for example, computation rule module 224.

Other portions of the rollbar 234 may allow the manager to modify factors and/or elements of a planning page. For example, the manager may modify an element for the base pay of an employee (such as percentage increase or gross amount of increase, etc.) and observe the effect of the modification on the employee's overall compensation package. As such modifications are entered, the computation engine performs all of the necessary cross calculations required to update the various fields that make up the subject employee's compensation as well as any other measures affected thereby. For example, as an individual employee's compensation is adjusted, those revisions may need to be reflected in the manager's available budget for compensation increases. Thus the employee's compensation may be linked to the manager's budget via, for example, data dictionary module 218. This budget, and the available and used portions thereof, may be reflected in the budget window 236.

The rollbar 234, budget window 236 and datagrid 232 are all examples of portlets. Portlets are pluggable user interface components that are displayed as a collection of non-overlapping windows within a web page. Thus, the view templates can be described as a collection of portlets grouped within web page containers therefor, which containers act as presentation vehicles for a user to be viewed as a generated planning page.

Different portlets may have different formats. For example, some portlets that are used in the view templates may include various columns into which data elements are populated. Others, like the rollbar, will include various panels, with each panel made up of individual columns, rows and/or cells into which data elements are populated. The format of the portlets may be described by XML schemas that describe the elements (columns, rows, cells, etc.) that are included therein. The XML templates may be combined in a table in the database, where they can be searched by page, portlet, view, business unit, company, etc.

The portlet definitions may make use of the schema-defined elements to construct datagrid, rollbars and other view constructs through which users can access and manipulate data regarding employee compensation packages. As indicated above, such data may be stored in a repository, such as database 110, in a fashion dictated by the database schemas. Thus, the portlets can extract such data from the repository according to meta information associated with the individual data entries. In this way, the views orchestrated by the view templates may be dynamically constructed in response to user requests therefor.

As indicated above, the data dictionary 218 is a memory resident module that contains definitions of the variables and calculations used by the compensation planning system. The individual elements of the data dictionary may be defined according to a schema.

As is apparent from these examples, data dictionary elements and/or factors may be described by a plurality of attributes, including, names, labels, tables (into which the data elements are organized), and in some cases, equations. These equations may define the cross-calculations which the computation engine may perform each time an individual data value, or element, is modified or updated for a given employee. In order to ensure that these computations are performed in a correct, non-blocking fashion, when the data dictionary is constructed prior to run time the equations may be parsed and copied into a calculation index table. That table may specify the order in which computations are to be run by the computation engine module 214. The output of the computations may be stored as updated variables in the respective tables therefor (defined in the data dictionary) and, if appropriate, returned to a view (defined by a view template) through, for example, an Ajax update or other process as is commonly used with Web-based applications.

As mentioned above, users may customize aspects of the compensation planning application through an administrative interface. Many of these customizations may include computations of specific compensation package variables, which may require an analysis of whether or not a particular employee qualifies for the benefit under consideration.

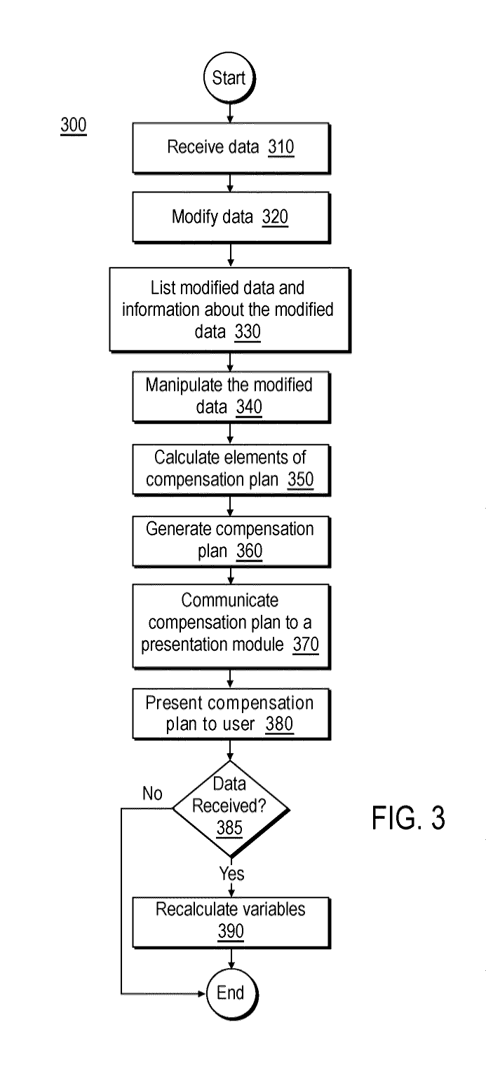

FIG. 3 illustrates a process 300 for generating a compensation plan for an enterprise. Process 300 may be performed with a configurable system, such as system 100 and may be performed at a server, such as server 120. In step 310, a configurable system for generating a compensation plan receives data. The data may be received from, for example, a database, such as database 110, or a user, such as user 140. In step 320, the data may be modified according to or to conform to a core database schema present in, for example, a core database schema module, such as core database schema module 216, or an extensible database schema present in an extensible database schema, such as extensible database schema module 220. The data may be modified to be compatible with other data within the system and/or compensation plan.

In step 330, the modified data and information about the modified data may be listed in, for example, a data dictionary, such as data dictionary module 218. The modified data may then be manipulated according to, for example, a defined rule set for compensation planning as in step 340. The defined rule set may be included in, for example, the above-described computation rules that comprise various compensation plans, which computation rules are defined within the equations within the data dictionary and which are evaluated by the computation engine.

Elements of the compensation plan may then be calculated, as in step 350. The calculations may be performed using, for example, the manipulated data, and may be calculated according to the computation rules. In step 360, a compensation plan may be generated based on, for example, the calculated elements.

In step 370, the compensation plan may be communicated to a presentation module, such as presentation module 130. The compensation plan may then be presented to a user, as in step 380 and process 300 may end. The compensation plan may be presented to the user as a planning page. A planning page may include data related to a portion of the compensation plan. Exemplary planning pages are shown in FIGS. 2A-2C.

Upon viewing the compensation plan, the user may enter data into the presented compensation plan and/or planning page. When such data is received, as in step 385, the compensation plan variables may be recalculated (step 390) and process 300 may end. If such data is not received, then process 300 may end after step 380.

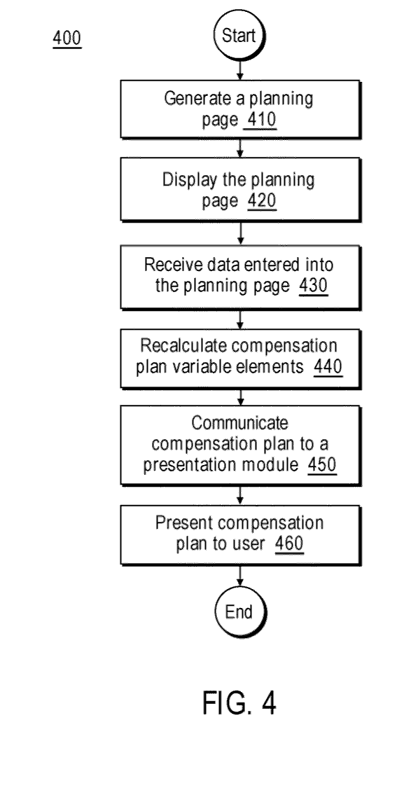

FIG. 4 illustrates an exemplary process 400 for generating a compensation plan for an enterprise. In step 410, a planning page showing a portion of a compensation plan is generated. The planning page may be generated by a system, such as system 100 using one or more view templates. The view template that may be used to generate the planning page may be generated and/or stored in a view template module, such as view template module 222. In step 420, the planning page is displayed to, for example, a user, such as user 140. The planning page may be displayed by, for example, a presentation module, such as presentation module 130 and may include one or more elements. In step 430, data entered into the planning page may be received. The received data may include, for example, defining a user specific data element, an application calculation, or a planning page to be presented to the user. The data entered may include activating a function within the planning page or selecting a option for a displayed element or data entered into the page. Then in step 440, compensation plan variable elements may be recalculated using the revised element. In step 450, the compensation plan may be communicated to a presentation module, such as presentation module 130, which may then display the compensation plan, or a planning page of the compensation plan, as in step 460, and process 400 may end.

Thus, a platform configured to facilitate total compensation package planning for workforces that may be made up of large numbers of geographically dispersed employees has been described.

What is claimed is:

1. A configurable system for generating a compensation plan for an enterprise, the system comprising:
an invariant core including a core business logic and presentation module, a core database module, and a computation engine module;
a plurality of dynamic modules including at least one of a data dictionary module, a computation rule module, an extensible database schema module, and a view template module, the dynamic modules accessible to modules comprising the invariant core; and
a database including data specific to the enterprise readable by at least one of the modules comprising the invariant core and one or more of the dynamic modules.

2. The system of claim 1, wherein the core business logic and presentation module is configured to manipulate data received from the database according to a rule set defining the compensation plan for the enterprise.

3. The system of claim 2, wherein the rule set includes rules specific to at least one of a government, a nation, a region, a locality, a custom, and the enterprise.

4. The system of claim 1, wherein the core business logic and presentation module includes presentation rules which define one or more view templates.

5. The system of claim 1, wherein the computation engine module is configured to compute variables within a compensation plan according to editable compensation rules defined through mathematical expressions stored in the data dictionary module.

6. The system of claim 1, wherein the core database schema module includes rules defining a format for data used by the system.

7. The system of claim 1, wherein the extensible database schema module defines enterprise-specific rules defining a format for data used by the system.

8. The system of claim 1, wherein the data dictionary uses schemas stored in the core database schema to define a variable to be included in a compensation plan.

9. The system of claim 1, wherein the data dictionary is a memory resident module.

10. The system of claim 1, wherein the view template module is configured to process at least one view template to facilitate formatting and display of data defined by the data dictionary module.

11. The system of claim 10, wherein the view template module reads the at least one view template, retrieves associated data described by the data dictionary module and produces display objects for a presentation module configured to present planning pages for the compensation plan.

12. A method for generating a compensation plan for an enterprise, the method comprising:
receiving enterprise-specific data from a database;
modifying the enterprise-specific data according to a schema to produce modified data compatible with other data in the compensation plan;
listing the modified data and information about the enterprise-specific data in a data dictionary;
manipulating the modified data according to a rule set for compensation planning to produce manipulated data;
calculating elements of the compensation plan, using the manipulated data, according to one or more computation rules described in the data dictionary;
generating variables within the compensation plan for the enterprise based on the calculated elements; and
presenting for user viewing the generated variables of the compensation plan.

13. The method of claim 12, wherein the variables within the compensation plan are generated at a server.

14. The method of claim 13, wherein the variables within the compensation plan are presented via a view template displayed by a web browser.

15. The method of claim 14, wherein the view template defines a planning page which displays a portion the compensation plan.

16. The method of claim 15, further comprising receiving via the planning page modifications to the compensation plan and regenerating the variables within the compensation plan based on the modifications.

17. The method of claim 12, wherein the rule set includes both enterprise-specific rules and enterprise-agnostic rules.

18. The method of claim 17, wherein the enterprise-agnostic rules include one or more rules defined by one or more of a government or geographic customary practices.

19. The method of claim 12, wherein the rule set is editable and defines the compensation plan through mathematical expressions.

20. The method of claim 12, wherein the rule set is includes a description of an order in which calculations must be performed.
